(19) United States
(12) Patent Application Publication
(10) Pub. No.: US 2025/0302062 A1
(43) Pub. Date: Oct. 2, 2025

(54) FAT-FREE SOFT CREAM CHEESE USING AGGREGATES OF PEA PROTEIN HYDROLYSATE

(71) Applicant: Purdue Research Foundation, West Lafayette, IN (US)

(72) Inventors: Da Chen, West Lafayette, IN (US); Dylan Limit, Lafayette, IN (US)

(73) Assignee: Purdue Research Foundation, West Lafayette, IN (US)

(21) Appl. No.: 19/093,543

(22) Filed: Mar. 28, 2025

Related U.S. Application Data
(60) Provisional application No. 63/572,582, filed on Apr. 1, 2024.

(51) Int. Cl. A23C 19/076; A23J 3/14; A23J 3/34

(52) U.S. Cl. CPC A23C 19/076; A23J 3/14; A23J 3/346

(57) ABSTRACT

A fat-free soft cream cheese and method of its preparation using aggregates of pea protein hydrolysate; A method of preparing aggregates of pea protein hydrolysate; its use as a fat replacer in fat-free soft cream cheese and other dairy products.

### CROSS-REFERENCE TO RELATED APPLICATION

This application claims priority to U.S. provisional patent application No. 63/572,582, which was filed Apr. 1, 2024, and which is hereby incorporated by reference in its entirety.

### TECHNICAL FIELD

The present disclosure relates to a method of preparing aggregates of pea protein hydrolysate using an enzyme, such as alcalase, and their use for preparing fat-free soft cream cheese and other fat-free dairy products.

### BACKGROUND

This section introduces aspects that may help facilitate a better understanding of the disclosure. Accordingly, these statements are to be read in this light and are not to be understood as admissions about what is or is not prior art.

Obesity is prevalent in the United States (˜43% for adults) and many other developed countries and contributes to the occurrence of many chronic diseases, such as cardiovascular disease, cerebrovascular diseases, diabetes mellitus, dyslipidemia, and malignancy and cancers. Excess calorie intake has been considered the main cause of obesity, with full-fat dairy products being the main contributor. Dairy consumption represents ˜10% of daily calorie intake in the USA, and full-fat dairy product plays a significant role (Bhupathi V. et al., Current Cardiology Reports, 2020, 22, 1-6). Consumption of low-fat or fat-free dairy products is thus highly recommended by USDA 20-25 dietary guidelines (Dietary Guidelines 2020-2025). However, low-fat dairy products commonly have inferior texture and sensorial properties, which customers do not widely accept (Lucca et al., Trends in Food Science and Technology, 1994, 5(1), 12-19).

Full-fat cream cheese contains 25-30% fat, whereas low-fat cream cheese has a maximum percentage fat content of 10%. The latter is produced mainly from low-fat or skim milk by acid or starter culture-induced coagulation of caseins. However, fat serves as a lubricant and structural matrix for cream cheese and starts to flocculate, coalesce, and disrupt at elevated temperatures and/or under shear (Lopez et al., Journal of Colloids and Interface Science, 2000, 229 (1), 62-71). Removal or reduction of fat from cheese leads to a harder texture, which can be alleviated by adding food hydrocolloids, emulsion, alkaline, or protein aggregates, including those derived from whey protein. However, not all of the whey protein-based fat replacers are able to enhance their rheological and textural properties (Meza et al., Dairy Science and Technology, 2010, 90(5), 589-599; Zalazar et al., International Dairy Journal, 2002, 12 (1), 45-50).

Animal and plant protein aggregates can be formed as fat replacers by controlled heat and/or shear. The animal protein is usually heated at 75-95° C. for 20-40 minutes for particulation to occur, whereas more extensive heating (80-95° C., ˜30 minutes) is required for most of the plant proteins, e.g., soy, pea, rice, and lentil, due to their higher thermal stability, even though they are considered a more sustainable source compared to those of animals (Kornet et al., Food Hydrocolloids, 2021, 117, 106691). Shortening the duration of heating at mild temperatures is thus essential to promote the efficiency of protein microparticle production as a fat replacer.

In view of the above, it is an object of the present invention to provide a method of preparing aggregates of pea protein with less heat requirement and improved product efficiency and their use as a fat replacer to produce fat-free dairy products, such as fat-free soft cream cheese with increased moisture content and enhanced rheological and textural properties. This and other objects and advantages, as well as inventive features, will be apparent from the detailed description.

### SUMMARY

Provided is a fat-free soft cream cheese comprising a moisture content of about 62% to about 70%; a protein content of about 28% to about 33%, wherein the protein content is a combination of a milk protein and a protein from aggregates of pea protein hydrolysate; and a viscosity of about 100 Pa·s at a shear rate of 10 s⁻¹ to about 1000 Pa·s at a shear rate of 10 s⁻¹. The storage modulus (G′) of fat-free soft cream cheese can be about 13 kPa to about 25 kPa. The fat-free soft cream cheese can further comprise an additive selected from a salt, a preservative, a color, a flavor, and a combination thereof. The fat-free soft cream cheese can be prepared using a dairy milk. Examples of the dairy milk include, but are not limited to, cow milk, goat milk, buffalo milk, or sheep milk.

Provided is a method of preparing a fat-free soft cream cheese, which method comprises:
(i) heating a suspension of pea protein isolates (PPI) in water;
(ii) hydrolyzing the suspension of PPI of step (i) using an enzyme alcalase to obtain a suspension of pea protein hydrolysates (PPH);
(iii) heating the suspension of PPH of step (ii) at a temperature of about 70° C. to about 90° C. to induce protein aggregation;
(iv) isolating aggregates of PPH; and
(v) mixing aggregates of PPH to a skim milk;
(vi) culturing the skim milk to form a cultured milk;
(vii) fermenting the cultured milk at acidic pH to form a curd; and
(viii) separating a whey and mixing the curd,
whereupon the fat-free soft cream cheese is formed.

The suspension of PPI in water can be heated at a temperature of about 50° C. to about 60° C. for about 5 min to about 15 min. The protein content in PPI suspension can be about 3% w/w to about 8% w/w. In step (iii), the suspension of PPH can be heated at a temperature above 70° C. In some embodiments, the suspension is heated at a temperature of about 80° C. to about 90° C. for about 5 min to about 30 min. The enzyme to substrate (E/S) ratio can be from about 1.5% to about 2.5%. PPH can be isolated in a powder form by freeze drying or spray drying the suspension comprising aggregates of PPH. In some embodiments, the cultured milk is fermented at a pH from about 4.6 to about 5.2. The aggregates of PPH can be added to the skim milk in step (v) in a concentration of about 0.1% w/w to about 0.5% w/w.

Provided is a method for preparing aggregates of pea protein hydrolysate (PPH), which method comprises:
(i) heating a suspension of pea protein isolates (PPI) in water;
(ii) hydrolyzing the suspension of PPI of step (i) using an enzyme alcalase to obtain a suspension of PPH;
(iii) heating the suspension of PPH of step (ii) at a temperature of about 70° C. to about 90° C. to induce protein aggregation; and
(iv) cooling and stirring the suspension of step (iii) at room temperature,
whereupon aggregates of PPH are formed.

The suspension of PPI can comprise a protein content of about 3% w/w to about 8% w/w. The suspension of PPI in water can be heated at a temperature of about 50° C. to about 60° C. for about 5 min to about 15 min. The pH of the suspension of PPI can be about 7.5 to about 8.5. In step (iii), the suspension of PPH can be heated at a temperature above 70° C. In some embodiments, the suspension is heated at a temperature of about 80° C. to about 90° C. for about 5 min to about 30 min. The enzyme to substrate (E/S) ratio used can be from about 1.5% to about 2.5%. The pH of the suspension of PPH can be about 7.

Further provided is a fat-free soft cream cheese prepared in accordance with the above-described method. A low-fat dairy food product comprising aggregates of pea protein hydrolysates, wherein the aggregates of pea protein hydrolysates are prepared according to the above-described method is provided.

### BRIEF DESCRIPTION OF THE DRAWINGS

The present disclosure will be more readily understood from the detailed description of embodiments presented below, considered in conjunction with the attached drawings of which:

FIG. 1 shows confocal laser scanning micrographs of aggregates of pea protein isolate (PPI) (see (a), (c)) and pea protein hydrolysate (PPH) (see (b), (d)). Images (a) and (b) represent samples, which were imaged after heating at 85° C. for 10 min and stirred. Images (c) and (d) represent the heated samples that were freeze-dried and re-suspended in water under stirring. The protein concentration of the samples was 5% (w/v). Image (e) represents the size distribution of re-suspended PPI or PPH aggregates.

FIG. 2 shows fat-free soft cream cheese with and without PPH or PPI aggregates at various concentrations, e.g., (a) fat-free cream cheese with 0.1% concentration of PPH or PPI, (b) fat-free cream cheese with 0.3% concentration of PPH or PPI, and (c) fat-free cream cheese with 0.5% concentration of PPH or PPI. The concentration indicates grams of PPH or PPI aggregate per 100 mL skim milk.

FIG. 3 shows the amplitude (a-c) and frequency sweep (d-f) of the fat-free cream cheese with various concentrations of PPH or PPI aggregates. Images (a), (b), and (c) represent 0.1%, 0.3%, and 0.5% concentration of PPH aggregates, respectively, and images (d), (e), and (f) represent 0.1%, 0.3%, and 0.5% concentration of PPI aggregates, respectively.

FIG. 4 shows the flow sweep (a-c) and temperature sweep (d-f) of the fat-free cream cheese with various concentrations of PPH or PPI aggregates. Images (a), (b), and (c) represent flow sweep of the fat-free soft cream cheese with 0.1%, 0.3%, and 0.5% concentration of PPH aggregates, respectively, and images (d), (e), and (f) represent temperature sweep of the fat-free cream cheese with 0.1%, 0.3%, and 0.5% concentration of PPI aggregates, respectively.

FIG. 5 shows creep recovery of the fat-free cream cheese containing various concentrations of PPH aggregates, e.g., (a) represents 0.1% concentration of PPH aggregates, (b) represents 0.3%, concentration of PPH aggregates, and (c) represents 0.5% concentration of PPH aggregates, and (d) and (e) represent fitting parameters of the fat-free soft cream cheese containing various concentration of PPI or PPH aggregates, respectively.

FIG. 6 shows the confocal micrographs of fat-free cream cheese containing various concentrations of PPH aggregates and PPI aggregates, e.g., images (b), (c), and (d) represent 0.1%, 0.3%, and 0.5% concentration of PPH aggregates, respectively and images (e), (f), and (g) represent 0.1%, 0.3% and 0.5% concentration of PPI aggregates respectively. Arrows highlight the presence of large aggregates.

FIG. 7 shows the scanning electron micrographs of fat-free cream cheese containing various concentrations of PPH aggregates and PPI aggregates, e.g., images (b), (c), and (d) in represent 0.1%, 0.3%, and 0.5% concentration of PPH aggregates, respectively, and images (e), (f), and (g) represent 0.1%, 0.3% and 0.5% concentration of PPI aggregates respectively.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

The terms “fat-free cream cheese” and “fat-free soft cream cheese” are used interchangeably.

Protein-based fat replacers are increasingly popular due to their low-calorie nature and customers' preference for high-protein foods. Nevertheless, their fabrication requires large energy input, which limits their food application. Full-fat cream cheese contains 25-30% fat, whereas low-fat cream cheese has a maximum percentage of fat content of 10%. The low-fat cream cheese is produced mainly from low-fat or skim milk by acid or starter culture-induced coagulation of caseins. However, fat serves as a lubricant and structural matrix for cream cheese and starts to flocculate, coalesce, and disrupt at elevated temperatures and/or under shear. Removal or reduction of fat from cheese leads to a harder texture, which can be alleviated by adding food hydrocolloids, emulsions, alkaline, or protein aggregates. However, not all protein-based fat replacers can enhance the rheological and textural properties of fat-free cheese.

In view of the above, a fat-free soft cream cheese is provided, prepared using a plant protein-based fat replacer. The plant protein used can be selected from a pea protein, a soy protein, a corn protein, a zein protein, and a wheat gluten. In some embodiments, the plant protein is a pea protein.

A green and energy-efficient method for preparing a plant protein-based fat replacer, such as aggregates of pea protein hydrolysate (PPH), and its use for preparing a fat-free soft cream cheese and other fat-free dairy products is provided. Examples of other dairy products include, but are not limited to, natural or processed cheese, cottage cheese, yogurt, buttermilk, and ice cream.

Provided is a method of preparing a fat-free soft cream cheese, which method comprises:
(i) heating a suspension of pea protein isolates (PPI) in water;
(ii) hydrolyzing the suspension of PPI of step (i) using an enzyme alcalase to obtain a suspension of pea protein hydrolysates (PPH);
(iii) heating the suspension of PPH of step (ii) at a temperature of about 70° C. to about 90° C. to induce protein aggregation;
(iv) isolating aggregates of PPH; and
(v) mixing aggregates of PPH to a skim milk;
(vi) culturing the skim milk to form a cultured milk;
(vii) fermenting the cultured milk at acidic pH to form a curd; and
(viii) separating a whey and mixing the curd,
whereupon the fat-free soft cream cheese is formed.

The suspension of PPI in water can be heated at a temperature of about 50° C. to about 60° C., such as about 50° C. to 60° C., 50° C. to about 60° C., or 50° C. to 60° C. The suspension can be heated for about 5 minutes to about 15 minutes, such as 5 minutes to about 15 minutes, about 5 minutes to 15 minutes, or 5 minutes to 15 minutes. In step (iii), the suspension of PPH can be heated at a temperature above 70° C. In some embodiments, the suspension is heated at a temperature of about 70° C. to about 90° C. In some embodiments, the suspension is heated at a temperature of about 75° C. to about 90° C. In some embodiments, the suspension is heated at a temperature of about 80° C. to about 90° C. In some embodiments, the suspension is heated at a temperature of about 75° C. to about 85° C. In some embodiments, the suspension is heated at a temperature of about 85° C. to about 90° C. The suspension can be heated for about 5 minutes to about 30 minutes, such as 5 minutes to about 30 minutes, about 5 minutes to 30 minutes, or 5 minutes to 30 minutes. In some embodiments, the suspension is heated for about 10 minutes to about 15 minutes (e.g., 10 minutes to 15 minutes). PPH can be isolated in a powder form by freeze drying or spray drying the suspension comprising aggregates of PPH. In some embodiments, the cultured milk is fermented at a pH from about 4.6 to about 5.2 (e.g., from 4.6 to 5.2) to form a curd. The curd can be heated to form a whey. After separating the whey, the curd can be mixed rapidly to produce fat-free soft cream cheese. The aggregates of PPH can be added to the skim milk in step (v) in a concentration of about 0.1% w/w to about 0.5% w/w.

In some embodiments, the fat-free cream cheese has a soft texture with a moisture content of about 62% to about 70%, such as about 62% to 70%, 60% to about 70%, or 62% to 70%. In some embodiments, the moisture content is about 63%. In some embodiments, the moisture content is about 65%. In some embodiments, the moisture content is about 66%. In some embodiments, the moisture content is about 68%. In some embodiments, the moisture content is about 70%. In some embodiments, the moisture content is about 72%. The total protein content of the fat-free cream cheese is a combination of a milk protein and a protein from aggregates of PPH. The protein content of the fat-free cream cheese can be about 25% to about 35%, such as about 25% to 35%, 25% to about 35%, or 25% to 35%. In some embodiments, the protein content of fat-free cream cheese is about 28% to about 33% (such as 28% to 33%). In some embodiments, the fat-free soft cream cheese has a viscosity of about 100 Pa·s at a shear rate of 10 s⁻¹ to about 1000 Pa·s at a shear rate of 10 s⁻¹. The storage modulus (G′) of fat-free soft cream cheese can be about 13 kPa to about 25 kPa, such as about 13 kPa to 25 kPa, 13 kPa to about 25 kPa or 13 kPa to 25 kPa.

Provided is a fat-free soft cream cheese comprising a moisture content of about 62% to about 70%; a protein content of about 28% to about 33%, wherein the protein content is a combination of a milk protein and a protein from aggregates of pea protein hydrolystae; and a viscosity of about 100 Pa·s at a shear rate of 10 s⁻¹ to about 1000 Pa·s at a shear rate of 10 s⁻¹. In some embodiments, the fat-free soft cream cheese has a storage modulus (G′) of about 13 kPa to about 25 kPa. The fat-free soft cream cheese can further comprise an additive selected from a salt, a preservative, a color, a flavor, and a combination thereof. The fat-free soft cream cheese can be prepared using dairy milk. Examples of dairy milk include, but are not limited to, cow milk, goat milk, buffalo milk, or sheep milk.

Provided is a method for preparing aggregates of pea protein hydrolysate (PPH), which method comprises:
(i) heating a suspension of pea protein isolates (PPI) in water;
(ii) hydrolyzing the suspension of PPI of step (i) using an enzyme alcalase to obtain a suspension of PPH;
(iii) heating the suspension of PPH of step (ii) at a temperature of about 70° C. to about 90° C. to induce protein aggregation; and
(iv) cooling and stirring the suspension of step (iii) at room temperature,
whereupon aggregates of PPH are formed.

The method further comprises converting aggregates of PPH to powder form by subjecting the suspension of PPH to a freeze-drying or spray-drying process. The method can produce aggregates of pea proteins with low heat requirements while improving production efficiency. PPI can be isolated from split peas. PPI has low allergenicity, high real ileal amino acids digestibility (RIDAA), digestible indispensable amino acid score, and high availability. Also, PPI has better aggregating capacity after hydrolysis. The hydrolysis of PPI can be carried out in water. Thus, the method avoids the use of any other solvents.

The protein content in PPI suspension in water can be about 3% w/w to about 8% w/w, such as about 3% w/w to 8% w/w, 3% w/w to about 8% w/w, or 3% w/w to 8% w/w. In some embodiments, the protein content is about 5% w/w (e.g., 5% w/w). The suspension of PPI in water can be heated at a temperature of about 50° C. to about 60° C., such as about 50° C. to 60° C., 50° C. to about 60° C., or 50° C. to 60° C., for about 5 minutes to about 15 minutes, such as 5 minutes to about 15 minutes, about 5 minutes to 15 minutes, or 5 minutes to 15 minutes. In some embodiments, the suspension is heated for about 5 minutes to about 10 minutes. Desirably, the suspension is heated for about 10 minutes. The pH of the suspension in step (i) can be adjusted from about 7.5 to about 8.5, such as about 7.5 to 8.5, 7.5 to about 8.5, or 7.5 to 8.5.

Enzyme alcalase is a protease enzyme prepared from the Bacillus licheniformis bacteria. Alcalase can hydrolyze PPI at an enzyme to substrate (E/S) ratio of about 1.5% to about 2.5%, such as about 1.5% to 2.5%, 1.5% to about 2.5%, or 1.5% to 2.5%. In some embodiments, the PPI is enzymatically hydrolyzed from about 30 seconds to about 2.5 minutes, such as about 30 seconds to 2.5 minutes, 30 seconds to about 2.5 minutes, or 30 seconds to 2.5 minutes. Desirably, PPI is enzymatically hydrolyzed for about 2 minutes (e.g., 2 minutes) to form pea protein hydrolystae (PPH). The protein aggregation can be induced by heating the suspension of PPH at above 70° C. In some embodiments, the suspension is heated at about 70° C. to about 90° C. In some embodiments, the suspension is heated at a temperature of about 75° C. to about 90° C. In some embodiments, the suspension is heated at a temperature of about 80° C. to about 90° C. In some embodiments, the suspension is heated at a temperature of about 75° C. to about 85° C. In some embodiments, the suspension is heated at a temperature of about 85° C. to about 90° C. The suspension can be heated for about 5 minutes to about 30 minutes, such as 5 minutes to about 30 minutes, about 5 minutes to 30 minutes, or 5 minutes to 30 minutes. In some embodiments, the suspension is heated for about 10 minutes to about 15 minutes (e.g., 10 minutes to 15 minutes). In some embodiments, the suspension is heated for about 10 minutes. The heating of the suspension inactivates the enzyme. The PPH aggregates can be isolated in powder form by cooling the suspension to room temperature, adjusting the pH to about 7, and subjecting the suspension to freeze-drying or spray-drying.

Fat-free cream cheese can be prepared by adding aggregates of PPH to a skim milk. The PPH aggregates can be incorporated at various concentrations. In some embodiments, the concentration of PPH aggregates is from about 0.1% w/w to about 0.5% w/w (e.g., 0.1% w/w to 0.5% w/w). In some embodiments, the concentration of PPH aggregates is 0.1%. In some embodiments, the concentration of PPH aggregates is 0.2%. In some embodiments, the concentration of PPH aggregates is 0.3%. In some embodiments, the concentration of PPH aggregates is 0.4%. In some embodiments, the concentration of PPH aggregates is 0.5%. The size of PPH aggregates can range from about 8 μm to about 60 μm. In some embodiments, the size of PPH aggregates can range from about 10 μm to about 60 μm. In some embodiments, the size of PPH aggregates can range from about 10 μm to about 55 μm. In some embodiments, the size of PPH aggregates can range from about 10 μm to about 50 μm. In some embodiments, the size of PPH aggregates can range from about 10 μm to about 48 μm. The PPH aggregates can have high heterogeneity and irregular shape. The fat-free cream cheese can be produced from a skim milk comprising aggregates of PPH by pre-warming a mixture of skim milk and the aggregates of PPH, fermenting the said mixture at about 25° C. to about 30° C. (e.g., 25° C. to 30° C.) at acidic pH to form a curd, heating the curd at a temperature above 50° C. to release whey, and mixing the separated curd at high speed to produce the fat-free soft cream cheese.

In comparison to the control sample, which had a rough surface and lack of consistency, the fat-free cream cheese obtained with PPH aggregates can be smooth, soft, and creamy. The fat-free cream cheese can have reduced viscoelasticity due to its high moisture content. Creep recovery test showed under the same stress, the strain (%) and α (elasticity), λ1 (elasticity modulus during creep), λ2 (elasticity modulus during recovery) of cream cheese containing PPH had much larger values than those of PPI. The confocal and scanning electron microscopy showed a less continuous network with large aggregates in PPH-contained cream cheese compared to those of PPI or negative control sample, possibly due to clustering of PPH or PPH-casein complex.

Still further provided is a low-fat dairy food product, comprising aggregates of PPH, wherein the aggregates of PPH are prepared according to the method described above. Examples of dairy products include, but are not limited to, natural or processed cheese, cottage cheese, yogurt, buttermilk, and ice cream.

### EXAMPLES

The following examples serve to illustrate the present disclosure. The examples are not intended to limit the scope of the claimed invention in any way.

### Materials

Commercial green split peas and skim milk (0.1% fat, w/w) was obtained from a local supermarket. Starter culture was purchased from Cultures for Health (Morrisville, North Carolina, USA), and Animal Rennet was purchased from New England Cheesemaking Supply Co. (Northampton, Massachusetts, USA). Alcalase Enzyme, E. 126741 (Bacillus licheniformis) was purchased from Sigma (EMD Millipore Corp., Burlington, Massachusetts, USA). All other chemicals used were of analytical grade. The water used was deionized.

### A] Pea Protein Extraction

Pea proteins were extracted using a method reported in the art (see Chen et al., Biomacromolecules, 2021, 22(2), 1001-1014), which is hereby specifically incorporated by reference for its teachings regarding the same.

Commercial green split peas (Pisum sativum) were ground to flour and passed through 100 mesh sieves. The flour was defatted using hexane, dried overnight, and suspended in water in a ratio of 1:7 (w/w, flour:water, w/w). The suspension was adjusted to pH 9.5, stirred for one hour at room temperature, centrifuged (13,000×g, 4° C., 15 minutes) to collect supernatant, and acidified to pH 4.5 to precipitate proteins. They were re-suspended in water and adjusted to pH 6.5 prior to freeze drying. The dried powder had a protein content of 84.41±0.28%, analyzed by the micro-Kjeldahl method with a nitrogen-to-protein conversation of 6.25.

### B] Preparation of Aggregates of Pea Protein Hydrolysate

Pea protein isolate (PPI) was dispersed in water to make a suspension of 5% (w/w) protein content. PPI suspension was placed at 55° C. for 10 minutes and adjusted to pH 8. Alcalase was then added to an enzyme-to-substrate ratio of 2% and hydrolyzed for 2 minutes. The hydrolysates were heated at 85° C. for 10 minutes to inactivate the enzyme and induce protein aggregation. Afterward, the suspension was cooled at 20° C. water bath, stirred at 300 rpm for 5 minutes, adjusted to pH 7 and freeze-dried for further use. The degree of hydrolysis was measured to be 5.0% using o-phthaldialdehyde (OPA) method (Chen et al., Food Hydrocolloids, 2022a, 128, 107547). The aggregates were imaged after being stained with 0.1% (w/v) fast green by confocal microscope prior to and post freeze-drying to explore the possible changes upon drying as the dried ingredient was more convenient for storage, formulation, and transportation.

### C] Preparation of Fat-Free Cream Cheese

Aggregates of PPI or PPH were added to skim milk and stirred (450 rpm) for 30 min with a final concentration of 0.1%, 0.3%, or 0.5% (w/w). Fat-free milk without the addition of PPI or PPH aggregates was used as a control. The mixture was pre-warmed at 28° C. for 30 minutes and mixed again, followed by the addition of starter culture (0.04 g) and rennet (50 μL/L milk). The samples were fermented at 28° C. (˜14.5 hours for PPH and PPI, ˜16.5 hours for control) until the pH reached 4.9±0.1. The formed curd was broken into pieces, followed by heating at 55° C. for 45 minutes to release whey. The whey was separated by draining through cheesecloth for five hours at room temperature, followed by pressing under 2 kg weight for 5 minutes, and then by squeezing to draw out the remaining liquid. Salt (0.5% w/w) and sodium azide were added to the curd and mixed at high speed (˜1000 rpm) for 4 minutes using a KitchenAid to acquire the cream cheese. They were packed in sealed containers and stored at 4° C. until further analysis. For each concentration of PPH or PPI aggregates, duplicates or triplicates were conducted.

### Analysis:

### Chemical Analysis of Cream Cheese

The moisture content of fat-free cream cheese was calculated based on its weight loss after heating at 105° C. for 24 hours and expressed as a percentage (%, w/w). The total protein content was measured using the Kjeldahl method with a N conversation factor of 6.38 (Rinaldoni et al., Food Science and Technology, 2014, 55(1), 139-147). The water holding capacity (WHC) was measured as described by Zhang, Y. et al. International Dairy Journal, 2022, 126, 105293, with slight modifications. An aliquot (˜1.5 g, m₀) of cream cheese was added to an ultra-centrifugal filter unit with a 3000 Da cut-off membrane and centrifuged (10,000×g, 15 min at 4° C.) to remove loosely bound water. The remaining weights of cream cheese were measured (m₁), and the water-holding capacity was calculated as follows: WHC (%)=m₁/m₀×100. Triplicates were conducted for each sample, and the average results were shown.

### Rheology of Cream Cheese

Cream cheese was carefully loaded onto a 20-mm hatched parallel plate with a geometry gap of 1 mm. An amplitude sweep ranging from 0.1% to 100% was conducted at 25° C. to determine the linear viscoelastic region. An oscillation frequency of 0.1-100 rad/s was also carried out at 25° C. at a fixed strain of 0.5%, which was within the linear viscoelastic regions. A steady flow sweep in a shear rate range of 0.1-100 s⁻¹ was performed at 25° C. to determine the viscosity of the cheese samples. To evaluate melting behavior where cream cheese was used under a baking or microwave environment, a temperature ramp from 20° C. to 95° C. at a rate of 5° C./min was also performed. The creep-recovery analysis was conducted on the same rheometer equipped with a 40 mm parallel plate geometry. The samples were soaked or rested for 120 seconds at 25° C. prior to measurement at 5 Pa stress for 15 minutes, followed by a recovery step of equal time (Chen et al., Biomacromolecules, 2021, 22(2), 1001-1014). The data was fitted with a model based on fractional calculus as shown below:

J(t)=ε(t)/σ₀=1/Γ_{(α+1)}(λ₁t^{α}−λ₂(t−tₘ)^{α}H(t−tₘ) (1)

J(t) is the material compliance, ε(t) is the strain, σ0 is the applied stress, tm is the time when stress is removed. The elasticity of the samples within the range of 0-1 was indicated by the value of α, with the larger value corresponding to the higher viscosity. The inverse of cream cheese elastic modulus would be shown with the value of λ₁ during creep and λ₂ during recovery.

### Confocal Laser Scanning Microscopy

PPH and PPI aggregates and cheese samples were mixed with 0.1% (w/v) fast green. The aggregates were imaged prior to and post-freeze-drying to explore the possible changes upon drying, as the dried ingredient was more convenient for storage, formulation, and transportation. The samples were transferred to concave slides covered with coverslips and sealed with epoxy glue prior to being imaged using Leica TCS SP8 X confocal microscope using 63×oil lenses under 633 nm excitation wavelength.

### Particle Size of PPH and PP Aggregates

Suspension of PPH or PP aggregates will be adjusted to pH 4.9 and pH 6.5. The particle size of PPH and PP aggregates was measured by Mastersizer 2000 with a reflective index of 1.45.

### Scanning Electron Microscopy (SEM)

Cheese samples were fixed with 0.1 M sodium cacodylate buffer (pH 7.4) containing 2.5% paraformaldehyde and 2.5% glutaraldehyde at room temperature for 8 hours. They were washed with water and dehydrated with a series of ethanol solutions (30%, 50%, 70%, 85%, 95%, 100%, and 100%) prior to being critical point dried. After drying, sample blocks were sputter coated with Au and imaged with Quanta 200F SEM at ˜9 mm working distance and 20 kV accelerating voltage. At least five different images were taken from two different blocks for each sample, and the representative image was shown.

### Statistical Analysis

A one-way analysis of variance (ANOVA) of the data was conducted by using Origin (OriginLab, Massachusetts, USA). The Fishers-least significant difference (LSD) test was used to evaluate the significant difference (P<0.05) between samples.

### D] Results:

### Aggregates of Pea Protein Hydrolysate

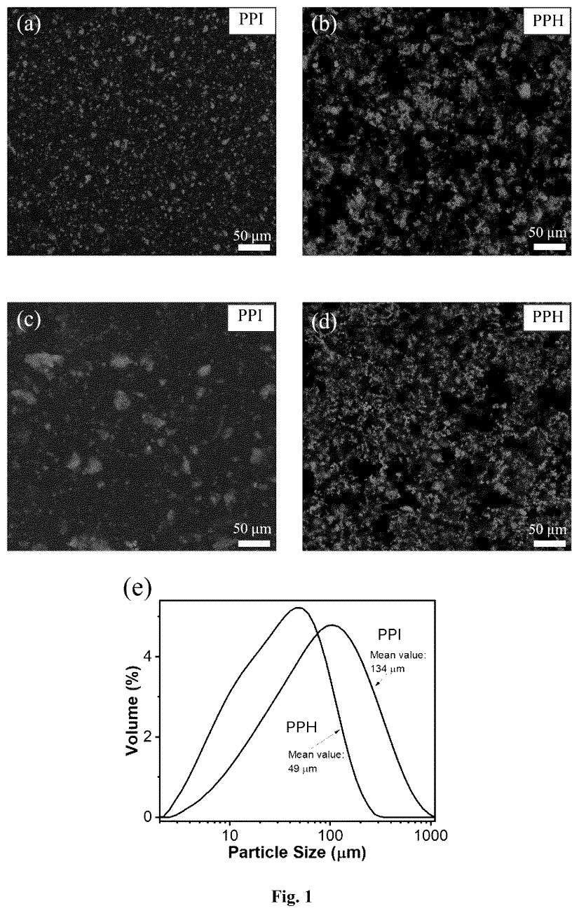

The morphology of protein aggregates has been shown to be closely associated with their fat mimic capacity. For instance, a spherical shape provides a better “ball-bearing” effect, resulting in improved lubrication, whereas an irregular shape would experience deformation or even disintegration, contributing to a soft and/or smooth texture. CLSM shows PPH aggregates had a size of 10-50 μm with high heterogeneity and irregular shape, whereas PPI aggregates were smaller with more uniform size and shape (FIG. 1). PPH was more vulnerable to heat after hydrolysis; thus, larger aggregates were formed. Pea protein solubility was expected to be around 90-93% at skim milk's pH condition (˜6.5), meanwhile, it decreased to 3-4% at cream cheese's pH condition (˜4.9). After freeze-drying and re-suspending in water, the PPH aggregates became smaller compared to those prior to freeze-drying. This is probably due to the disruption of large aggregates during mixing. PPH aggregates were mediated mainly through non-covalent interactions, which were vulnerable to shear. The opposite observation was found in PPI, where larger aggregates were produced after reconstitution. This has been confirmed by the particle size distribution (FIG. 1, image e). The mean size of the PPI aggregates was ˜134 μm, and a much smaller value (49 μm) was found in PPH aggregates. Removal of water during the lyophilization process may promote the formation of large protein aggregates via van der Waals force. Part of the aggregates could survive during the re-suspending process.

### Appearance of Fat-Free Cream Cheese

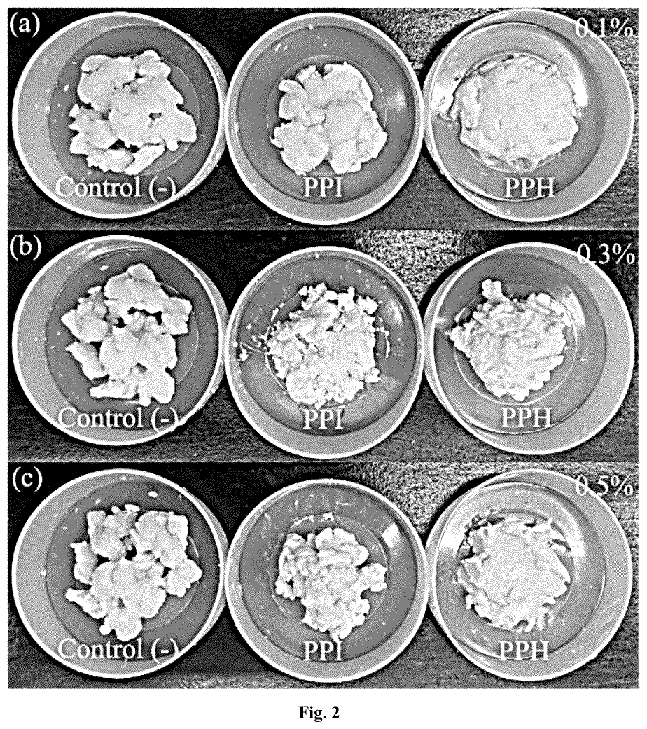

The incorporation of PPH or PPI aggregate to cream cheese resulted in a distinct appearance compared to those of the control (FIG. 2). The controlled cream cheeses were composed of separated curds with rough surface and lack of consistency. With the addition of 0.1% PPI aggregate, the cheese became more intact and had a moist appearance, even though a large chunk was also observed. However, the incorporation of 0.1% PPH aggregate produced a smooth and creamy appearance of the cheese. Further increase in the concentration of PPH aggregate resulted in improvement of the smoothness and consistency, whereas for PPI aggregates, only a slight improvement was found with crumbing appearance. The graphs clearly indicate a higher fat mimic capacity of PPH aggregates over those of PPI.
Table 1 illustrates the analysis and measurement of protein content, moisture content, and water holding capacity of the fat-free cream cheese.

TABLE 1

| | Protein | Moisture | Water Holding |
|---|---|---|---|
| Samples | Content (%) | Content (%) | Capacity (%) |
| Control | 30.68 ± 1.03 ^{B} | 63.97 ± 1.11 ^{Cd} | 98.49 ± 0.43 ^{AB′} |
| (—) | | | |
| PPI 0.1% | 33.30 ± 0.82 ^{A} | 62.99 ± 1.09 ^{d} | 98.92 ± 0.13 ^{A′} |
| PPH 0.1% | 30.41 ± 0.12 ^{B} | 63.19 ± 0.44 ^{d} | 98.04 ± 0.39 ^{AB′} |
| PPI 0.3% | 27.91 ± 0.58 ^{C} | 65.59 ± 0.01 ^{bC} | 96.30 ± 0.53 ^{Cd′} |
| PPH 0.3% | 27.83 ± 0.38 ^{C} | 70.18 ± 0.76 ^{a} | 95.86 ± 0.92 ^{d′} |
| PPI 0.5% | 27.28 ± 0.62 ^{C} | 66.69 ± 0.62 ^{b} | 97.55 ± 0.39 ^{BC′} |
| PPH 0.5% | 27.83 ± 1.0.12 ^{C} | 70.24 ± 0.93 ^{a} | 95.77 ± 0.76 ^{D′} |

Letters indicate the significant difference (P < 0.05) among the data in the same column.

### Chemical Analysis of Cream Cheese

The quality of cream cheese associates closely with its chemical composition. The protein content in the cheese ranged from 27.3% to 33.3% (Table 1). No significant difference was found between the control (−) samples and those containing 0.1% PPH aggregate (P≥0.05). With the increased addition of PPI or PPH aggregates, the protein content was reduced gradually (P<0.05). The reduction was most likely due to decreased casein coagulation, and part of the casein was drained into the whey. No significant difference in the protein content was found between the cheese containing PPI and PPH aggregates except at 0.1% concentration (P≥0.05). The moisture content shows an opposite trend compared to protein content. The higher the concentration of PPH or PPI aggregates in the cream cheese, the higher the moisture content. A similar observation has been found on low-fat soft cheese, where the addition of a fat replacer increased the moisture content. The water-holding capacity (WHC) of cream cheese with 0.1% PPH or PPI aggregates showed no significant difference compared to the control (−) (P≥0.05). When more PPH or PPI aggregates were incorporated, lower WHC was observed. In the presence of PPH or PPI, the extent of kappa-casein hydrolysis could be reduced because of the blocking of some accessible sites towards chymosin. Thus, less water was immobilized. Compared to PPI, cheese with PPH aggregates at equivalent concentrations had lower WHC. When proteins are being hydrolyzed, it become smaller, and more polar groups are exposed on the surface of aggregate to interact with water. The previous finding revealed decreased surface hydrophobicity of PPH aggregate (Chen et al., 2022a, Food Hydrocolloids, 128, 107547) compared to the PP. Therefore, the lower WHC should be mainly attributed to decreased water immobilization from the casein network instead of pea proteins.

### Rheological Measurement

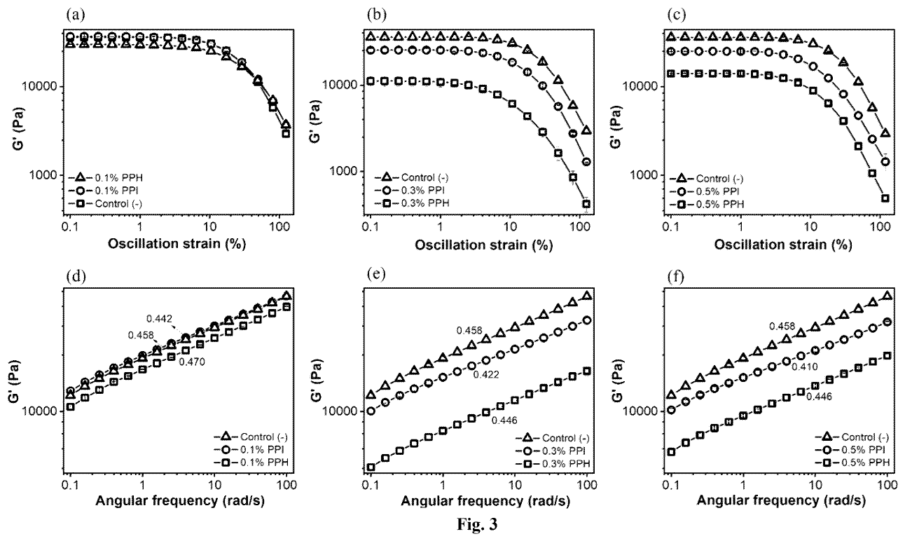

The effect of PPH or PPI aggregates on the rheological properties of cream cheese was investigated by conducting multiple tests. The amplitude sweep showed a linear viscoelastic region (LVR) followed by a non-linear region for all of the samples (FIG. 3). The maximum strain in the LVR (critical strain) was ˜10% for the control samples. It was decreased to ˜8% and 3% at 0.1% and 0.3% PPH, respectively. This implies that the cheese was more vulnerable to being disrupted. Further, increasing the PPH aggregates to 0.5% content showed negligible effect on the critical strain. For cheese containing PPI aggregates, the critical strain at 0.1% concentration was similar to the control. A slight decrease was observed at 0.3% and 0.5% concentration. The critical strain was always lower in cream cheese containing PPH aggregates compared to PPI at the same concentration, indicating the former had less crosslinks or loosened structures that were easier to deform. The storage modulus (G′) of cream cheese was decreased when PPH aggregates were incorporated with the lowest value at 0.3% concentration. This suggests the softening effect of cream cheese by PPH aggregates (Chen et al., Biomacromolecules, 2021, 22(2), 1001-1014). Lower G′ of cheese samples containing PPH aggregates than those of PPI at the same concentration suggests their stronger softening capacity, which is possibly due to the formation of less intact networks by disruption of more casein-casein interactions. In the frequency sweep, G′ was increased with the increase of frequency with G′>G″, indicating the cheese samples are physical gels. The degree of frequency dependence (n) for physical gels can be calculated from the power-law equation G′=K ωⁿ. n is 0 for covalent gels, and it is positive for physical gels. n value was 0.458 for the control cheese and decreased slightly in those containing 0.3% and 0.5% PPH aggregates, but remarkably at the same concentration of PPI. The n value of protein gels directly links to the relaxation rate of protein molecules, which is further governed by the molecular rigidity and the connecting elastic spring within the protein network. The former might be reduced by PPI aggregates via disrupting casein-casein interactions due to their higher hydrophobicity compared to PPH aggregates (Chen et al., Food Hydrocolloids, 2022a, 128, 107547). Alternatively, PPH could also induce aggregation of caseins, resulting in increased molecular rigidity, meanwhile producing segregated networks that reduce elastic spring. The counter effects lead to negligible changes in the n value.

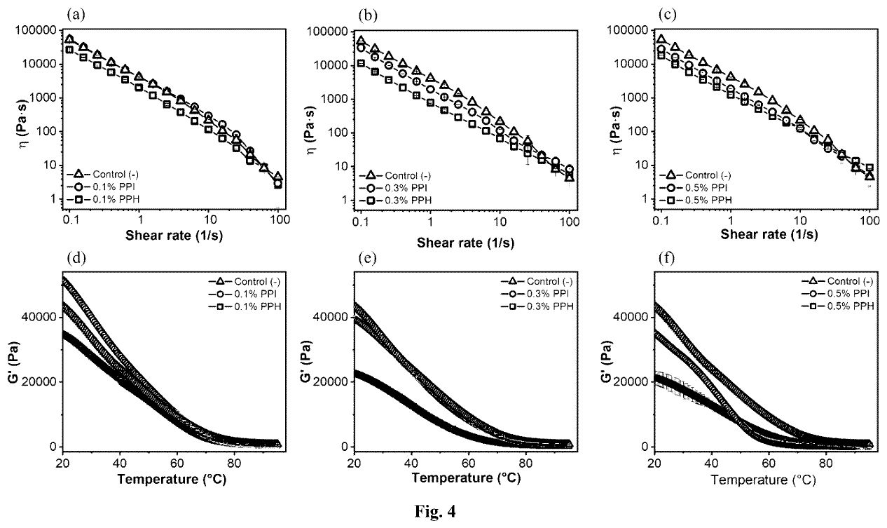

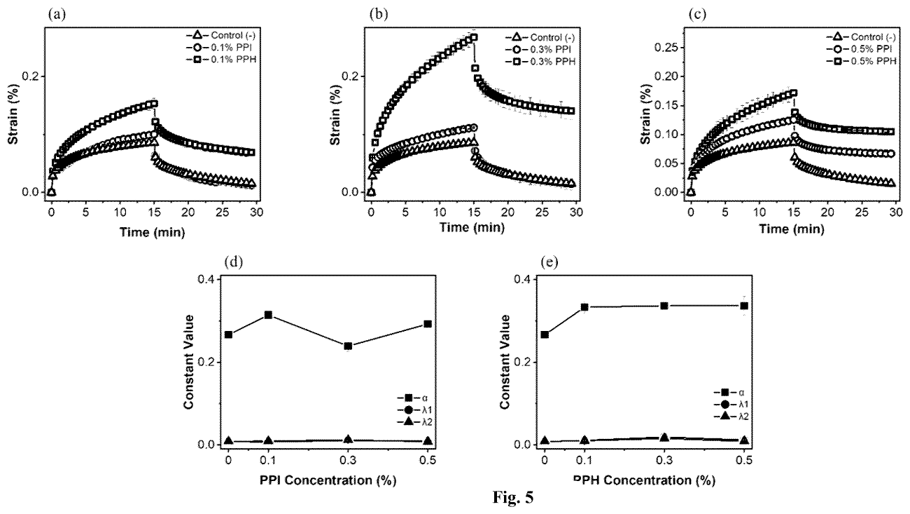

The apparent viscosity (η) of cream cheese was decreased with the increase of shear rate (FIG. 4). This is the typical shear thinning behavior. At the shear rate of 0.1-40 s⁻¹, the η of cheese samples with 0.3% and 0.5% PPH or PPI aggregates was significantly lower than those at 0.1% concentration and the control groups. Lower η suggests that the casein-casein interactions or intactness of the casein network were less in the samples. Compared to the samples with 0.3% PPH or PPI aggregates, those at 0.5% concentration had higher η, which may be attributed to increased interactions between PPH or PPI and casein micelles. At the shear rate between 40 and 100 s⁻¹, the viscosity of cheese with 0.3% and 0.5% PPH aggregates was comparable to those of PPI and the control groups. Under a large shear, extensive structural disruption of cheese would occur, which would dilute the original difference in gel networks or protein-proteins among the samples (see FIG. 5).

To observe the melting behavior of the cheese samples, the changes of G′ was monitored with the increase of temperature, and the result is shown in FIG. 4. Usage of cream cheese at high-temperature environments such as baking has also been found (Korean garlic cream cheese bread). Investigating the response of cream cheese towards higher temperatures is thus essential for such applications. G′ was decreased rapidly from 20 to 70° C. for all samples, indicating a softening effect at elevated temperatures. Similar observations have been reported in akawi cheese, reduced-fat processed cheese and full-fat cream cheese. In fat-free cheese, casein networks are the dominant contributors of G′ stabilized mainly by hydrogen bonds and hydrophobic interactions. Those non-covalent interactions are weakened with the increase in temperature. Besides interactions, the molecular rigidity of casein was also found to decrease at higher temperatures, which further contributes to a lower elasticity. Cream cheese containing PPH aggregates had lower G′ than PPI and control (−) groups at a temperature from 20 to 50° C., presumably due to more extensive interruption of the casein network. From 70 to 95° C., the G′ of treatment and control groups were steady and similar. Under such temperatures, the non-covalent interactions among caseins are expected to be limited, thus their contribution to the elasticity of cheese should be negligible.

The viscoelastic properties of cream cheese could also be reflected by the creep-recovery test. Differed from oscillation, creep-recovery assesses the deformation (strain) of materials at the axial direction under constant stress with time and their recovery once the stress was withdrawn. The strain of cream cheese was increased with PPH or PPI aggregate within 0.3% concentration. Further increase of the concentration reduced the strain. Higher strain in samples containing 0.3% PPH or PPI aggregates suggests the formation of fewer interactions or a weaker network. After fitting the data with the fractional calculus model, the parameters of elasticity (α), the inverse of elastic modulus in creep (λ1), and recovery (λ2) were acquired. α value of 0 corresponds to purely elastic materials, whereas of 1 corresponds to purely viscous materials. The fat-free cream cheese samples had values of 0.2-0.4, indicating the dominance of the elasticity of the system. The parameters α, λ1, and λ2 were increased with the increase of PPH content, which indicates a decrease in gel elastic moduli or strength. The values of λ1 and λ2 were nearly identical. This implies the applied stress did not cause permanent deformation to the cheese samples during the creep step, and the samples were able to recover their structure.

### Microstructures

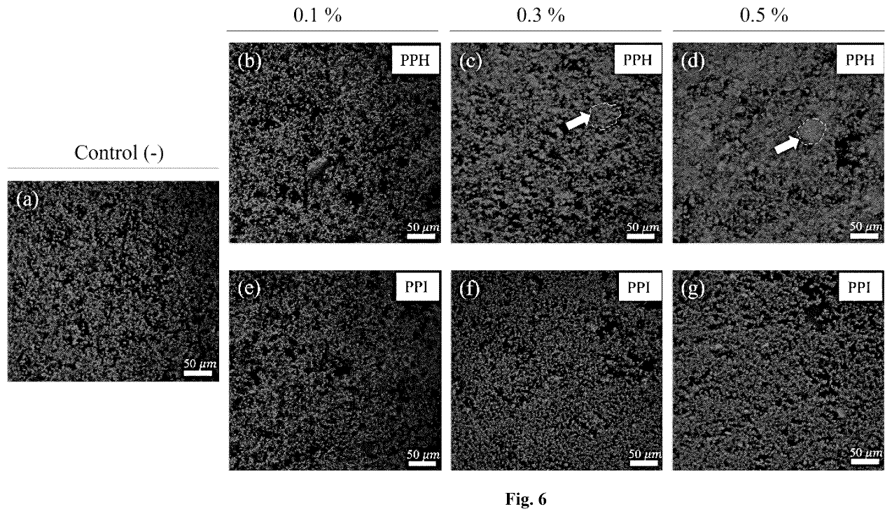

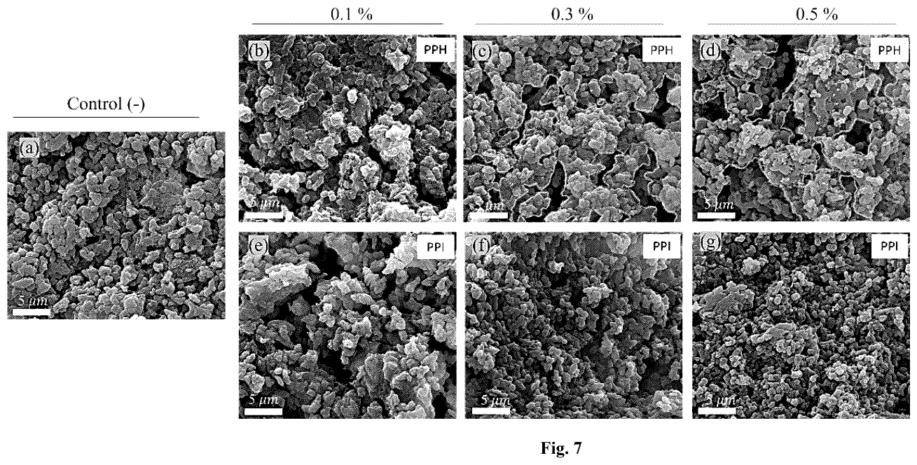

Besides protein-protein interactions, the microstructure of cheese is another factor that affects its viscoelasticity. CLSM was first conducted with minimal sample pre-treatment to observe the results. The micrographs showed that the protein network in the cheese sample containing 0.1% PPH or PPI was less homogenous and continuity compared to those of the control, especially PPH (FIG. 6, images a-c). With the increase of PPH or PPI concentration, the network became denser. Compared to PPI samples, the network of those containing PPH was coarser with the presence of a higher proportion of large aggregates. These aggregates could be pea proteins-casein complexes. It was known that acidification induced the formation of large and sedimentable pea protein-casein micelle aggregates. Even though CLSM enables the microstructure of cheese samples to be shown in hydrated states, the resolution is limited. SEM was thus conducted to envisage the structure at micro- to nano-level. For the control, the proteins were densely packed with mainly small structural units of 0.1-1 μm, which could be individual casein micelle or their aggregates. The structure became porous and less continuous with the presence of cracks when 0.1% PPH or PPI aggregates was incorporated (FIG. 7), which may contribute to reduced elasticity. At 0.3% and 0.5% PPH, aggregates were observed in cheese samples. They were assembled of small structural units. The small structural units were more homogenous and densely distributed in cheese containing PPI aggregates at the same concentration, which may lead to its higher elasticity.
While specific embodiments of the subject invention have been disclosed herein, the above specification is illustrative and not restrictive. While this invention has been particularly shown and described with references to preferred embodiments thereof, it will be understood by those skilled in the art that various changes in form and details may be made therein without departing from the scope of the invention encompassed by the appended claims. Many variations of the invention will become apparent to those of skilled art upon review of this specification. Unless otherwise indicated, all numbers expressing reaction conditions, quantities of ingredients, and so forth, as used in this specification and the claims, are to be understood as being modified in all instances by the term “about.” Accordingly, unless indicated to the contrary, the numerical parameters set forth herein are approximations that can vary depending upon the desired properties sought to be obtained by the present disclosure.

As used herein, the following terms and phrases shall have the meanings set forth below. Unless defined otherwise, all technical and scientific terms used herein have the same meaning as commonly understood to one of ordinary skill in the art.

The term “about” can allow for a degree of variability in a value or range, for example, within 10%, within 5%, or within 1% of a stated value or of a stated limit of a range.

The term “substantially” can allow for a degree of variability in a value or range, for example, within 90%, within 95%, or within 99% of a stated value or of a stated limit of a range.

The terms “a,” “an,” or “the” are used to include one or more than one unless the context clearly dictates otherwise. The term “or” is used to refer to a nonexclusive “or” unless otherwise indicated. In addition, the phraseology or terminology employed herein, and not otherwise defined, is for the purpose of description only and not of limitation. Any use of section headings is intended to aid reading of the document and is not to be interpreted as limiting. Further, information that is relevant to a section heading may occur within or outside of that particular section. The terms “including” and “having” are defined as comprising (i.e., open language).

Those skilled in the art will recognize that numerous modifications can be made to the specific implementations described above. The implementations should not be limited to the particular limitations described. Other implementations may be possible.

It is intended that the scope of the present methods and apparatuses be defined by the following claims. However, it must be understood that this disclosure may be practiced otherwise than is specifically explained and illustrated without departing from its spirit or scope. It should be understood by those skilled in the art that various alternatives to the embodiments described herein may be employed in practicing the claims without departing from the spirit and scope as defined in the following claims.

We claim:

1. A fat-free soft cream cheese comprising a moisture content of about 62% to about 70%; a protein content of about 28% to about 33%, wherein the protein content is a combination of a milk protein and a protein from aggregates of pea protein hydrolysate; and a viscosity of about 100 Pa·s at a shear rate of 10 s⁻¹ to about 1000 Pa·s at a shear rate of 10 s⁻¹.

2. The fat-free soft cream cheese of claim 1, wherein the fat-free soft cream cheese has a storage modulus (G′) of about 13 kPa to about 25 kPa.

3. The fat-free soft cream cheese of claim 1, wherein the fat-free soft cream cheese is prepared using a dairy milk.

4. The fat-free soft cream cheese of claim 3, wherein the dairy milk is cow milk, goat milk, buffalo milk, or sheep milk.

5. The fat-free soft cream cheese of claim 1, wherein the fat-free soft cream cheese further comprises an additive selected from a salt, a preservative, a color, a flavor, and a combination thereof.

6. A method of preparing a fat-free cream cheese, which method comprises:
(i) heating a suspension of pea protein isolates (PPI) in water;
(ii) hydrolyzing the suspension of PPI of step (i) using an enzyme alcalase to obtain a suspension of pea protein hydrolysates (PPH);
(iii) heating the suspension of PPH of step (ii) at a temperature of about 70° C. to about 90° C. to induce protein aggregation;
(iv) isolating aggregates of PPH;
(v) mixing aggregates of PPH to a skim milk;
(vi) culturing the skim milk to form a cultured milk;
(vii) fermenting the cultured milk at acidic pH to form a curd; and
(viii) separating the whey and mixing the curd,
whereupon the fat-free cream cheese is formed.

7. The method of claim 6, wherein the suspension of PPI in step (i) is heated at a temperature of about 50° C. to about 60° C.

8. The method of claim 6, wherein the suspension of PPH in step (iii) is heated at a temperature of about 80° C. to about 90° C.

9. The method of claim 6, wherein the aggregates of PPH are isolated in a powder form by a freeze-drying or a spray-drying of the suspension of PPH.

10. The method of claim 6, wherein a concentration of aggregates of PPH used in step (v) is of about 0.1% w/w to about 0.5% w/w.

11. The method of claim 6, wherein the suspension of PPI comprises a protein content of about 3% w/w to about 8% w/w.

12. The method of claim 6, wherein a ratio of the enzyme alcalase and PPI used is from about 1.5% to about 2.5%.

13. The method of claim 6, wherein the acidic pH is from about 4.6 to about 5.2.

14. A method for preparing aggregates of pea protein hydrolysate (PPH), which method comprises:
(i) heating a suspension of pea protein isolates (PPI) in water;
(ii) hydrolyzing the suspension of PPI of step (i) using an enzyme alcalase to obtain a suspension of PPH;
(iii) heating the suspension of PPH of step (ii) at a temperature of about 70° C. to about 90° C. to induce protein aggregation; and
(iv) cooling and stirring the suspension of PPH of step (iii) at room temperature,
whereupon aggregates of PPH are formed.

15. The method of claim 14, wherein the suspension of PPI comprises a protein content of about 3% w/w to about 8% w/w.

16. The method of claim 14, wherein the suspension of PPI in step (i) is heated at a temperature of about 50° C. to about 60° C. for about 5 min. to about 15 min.

17. The method of claim 14, wherein the suspension of PPH in step (iii) is heated at a temperature of about 80° C. to about 90° C. for about 5 min to about 30 min.

18. The method of claim 14, wherein a pH of the suspension of step (i) is about 7.5 to about 8.5.

19. The method of claim 14, wherein a ratio of the enzyme and PPI used is from about 1.5% to 2.5%.

20. The method of claim 14, wherein a pH of the suspension of step (iv) is about 7.
